(19) United States
(12) Patent Application Publication
(10) Pub. No.: US 2026/0353173 A1
(43) Pub. Date: Nov. 5, 2026

(54) METHODS, ARCHITECTURES, APPARATUSES AND SYSTEMS FOR ENABLING EXTENDED REALITY AWARE MULTIPATH ACCESS

(71) Applicant: InterDigital Patent Holdings, Inc., Wilmington, DE (US)

(72) Inventors: Xavier De Foy, Kirkland (CA); Michael Starsinic, Newtown, PA (US); Rocco Di Girolamo, Laval (CA); Magurawalage Chathura Madhusanka Sarathchandra, London (GB); Samir Ferdi, Kirkland (CA); Achref Methenni, Montreal (CA)

(21) Appl. No.: 19/483,050

(22) PCT Filed: May 10, 2024
(86) PCT No.: PCT/US2024/028974

§ 371 Date: Nov. 10, 2025

Related U.S. Application Data
(60) Provisional application No. 63/465,600, filed on May 11, 2023.

(51) Int. Cl. H04W 28/02; H04W 76/22

(52) U.S. Cl. CPC H04W 28/0268; H04W 76/22

(57) ABSTRACT

Procedures, methods, architectures, apparatuses, systems, devices, and computer program products for protocol data unit (PDU) set-aware steering of PDUs using multiple accesses or links. For example, uplink and/or downlink traffic may be transmitted using a PDU set-aware steering mode. The PDU set-aware steering mode may refer to, include, and/or otherwise use one or more steering algorithms which are applied to (e.g., steer) PDUs of a PDU set. The PDU set-aware steering mode may be used to determine one or more accesses to be used to transmit, in the uplink and/or downlink, a PDU of a PDU set from among multiple different accesses. A PDU set may carry information of application data units (ADUs) that are handled together by an application. Steering of PDU sets among multiple accesses may improve the Quality of Experience associated with use of the application, such as in the case of extended reality (XR) traffic flows.

### CROSS-REFERENCE TO RELATED APPLICATIONS

This application claims the benefit of U.S. Provisional Patent Application No. 63/465,600 filed 11 May 2023, which is incorporated herein by reference in its entirety.

### TECHNICAL FIELD

The present disclosure is generally directed to the fields of communications, software and encoding, including, for example, to methods, architectures, apparatuses, systems directed to wireless communication systems, and more particularly, to steering of protocol data units (PDUs) on a PDU set by PDU set basis.

### BACKGROUND

User equipment may be capable of both 3^{rd} Generation Partnership Project (3GPP) access and non-3GPP access. This capability can provide flexibility to network operators in determining which access to use for a service data flow. Access Traffic Steering, Switch and Splitting (ATSSS) was introduced in 3GPP Release 16 and further enhanced in Release 17 to take advantage of this flexibility.

There is a need to improve ATSSS for traffic flows, such as extended reality (XR) flows associated with wireless transmit/receive units (WTRUs) and application servers, in wireless networks.

### SUMMARY

In a first representative embodiment, a network entity (e.g., a UPF) may perform any of the following. For example, a UPF may receive an N4 session establishment/modification request. The N4 session establishment/modification request may include a PDU set-aware steering mode. The request may include associated parameters, such as configuration information, for the PDU set-aware steering mode. The UPF may configure a steering functionality with a PDU set-aware steering mode. The UPF may configure associated parameters for the PDU set-aware steering mode. The UPF may receive at least one PDU associated with a PDU set and one or more PDU set IEs. The UPF may obtain at least one PDU set IE associated with a (e.g., respective) PDU. The UPF may use one or more of the PDU set IEs, associated parameters, and/or the PDU set-aware steering mode to select an access for at least one (e.g., the respective) PDU. The UPF may send the at least one (e.g., the respective) PDU over the selected access.

In a second representative embodiment, a WTRU (e.g., UE) may receive information indicating “network support for PDU set-aware steering” from the network. The WTRU may use the indication of network support for PDU set-aware steering to determine and/or specify PDU set-aware steering capabilities. The WTRU may trigger establishment (e.g., trigger) of an (e.g., XR) application session. The WTRU may determine to trigger the establishment of a MA-PDU session. The WTRU may send a PDU Session establishment/modification request. The PDU Session establishment/modification request may include information specifying one or more PDU set-aware steering capabilities. The WTRU may receive a PDU session establishment/modification response. The PDU session establishment/modification response may include information indicating one or more ATSSS rules, such as a PDU set-aware steering mode. The ATSSS rules may include associated parameters (e.g., configuration information) for the PDU set-aware steering mode. The WTRU may configure a steering functionality with a PDU set-aware steering mode. The WTRU may (e.g., application executed by the WTRU may cause the WTRU to) send at least one PDU associated with a PDU set and one or more PDU set IEs. The WTRU may use at least one of the PDU set IEs, PDU set-aware steering mode and/or associated configuration information to select the access for the at least one PDU. The WTRU may send the at least one PDU over the selected access.

In a third representative embodiment, a WTRU may receive, from a network entity, information indicating a protocol data unit (PDU) set-aware steering mode (e.g., associated with a multi-access PDU (MA PDU) session). The WTRU may determine one or more steering algorithms associated with the PDU set-aware steering mode. The WTRU may determine one or more accesses of the MA PDU session for a PDU of a PDU set associated with a traffic flow generated by the WTRU using the one or more steering algorithms and one or more PDU set information elements associated with the PDU set. The WTRU may send, to an application server, the PDU using the determined one or more accesses of the MA PDU session. For example, the information indicating the PDU set-aware steering mode may be received in an establishment or modification response message from the network entity and may be associated with the MA PDU session. For example, the traffic flow may be generated by an application executed by the WTRU.

For example, the PDU set information elements may include information indicating any of an identifier, a start indication, an end indication, a sequence number, a size, an importance, an error rate, a delay budget, an integration indication, a burst periodicity, a dependence, a payload modality, and/or a forward error correction indication of the PDU set.

For example, before the information indicating the PDU set-aware steering mode is received, the WTRU may receive information indicating network support for PDU set-aware steering.

For example, the WTRU may send, to the network entity, a PDU session establishment or modification request which includes information indicating one or more requested PDU set-aware steering modes to a network entity. The received PDU set-aware steering mode may be one of the requested PDU set-aware steering modes.

In certain representative embodiments, a WTRU, may receive, from a network entity (e.g., SMF), information indicating a PDU set-aware steering mode associated with a MA-PDU session. The WTRU may determine one or more accesses of the MA-PDU session for a PDU of a PDU set of a traffic flow generated by the WTRU. For example, the WTRU may use the PDU set-aware steering mode and PDU set IEs associated with the PDU set to determine the one or more accesses. The WTRU may send, to an application server, the PDU using the determined one or more accesses.

In certain representative embodiments, a first network entity (e.g., UPF) may receive, from a second network entity (e.g., SMF 183), a N4 message including information indicating a PDU set-aware steering mode associated with a MA-PDU session. The first network entity may receive, from an application server, a PDU of a PDU set of a traffic flow associated with a WTRU. The first network entity may determine one or more accesses of the MA-PDU session for the PDU of the PDU set. For example, the first network entity may use the PDU set-aware steering mode and PDU set information elements IEs associated with the PDU set to determine the one or more accesses. The first network entity may send, to the WTRU, the PDU using the determined one or more accesses.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communication system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A is a procedural diagram illustrating example communications for establishment and/or modification and operation of a MA-PDU session using a PDU set-aware steering mode;

FIG. 2B is a procedural diagram illustrating a continuation of FIG. 2A;

FIG. 3 is a procedural diagram illustrating an example procedure for PDU set-aware steering for uplink traffic; and

FIG. 4 is a procedural diagram illustrating an example procedure for PDU set-aware steering for downlink traffic.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

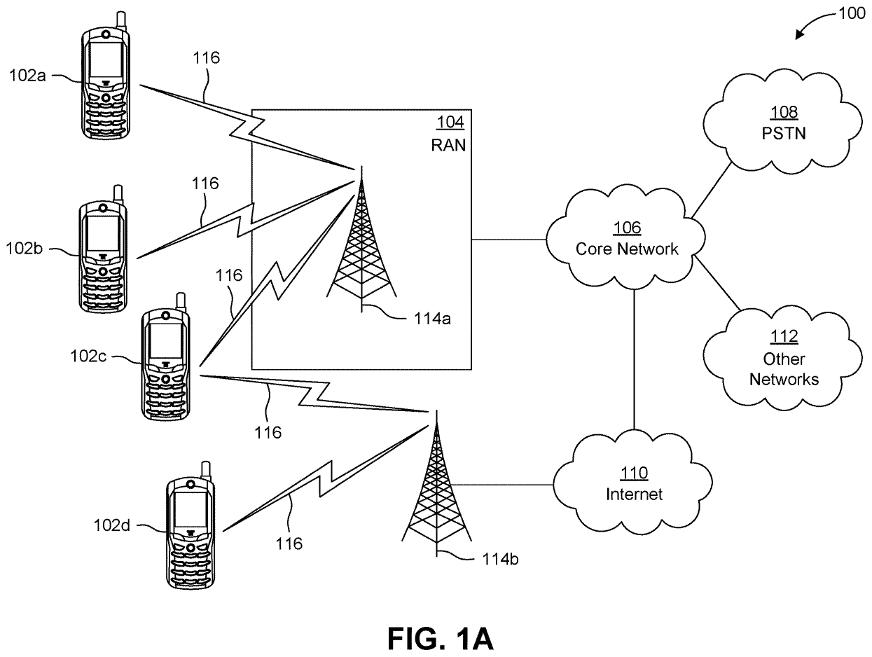

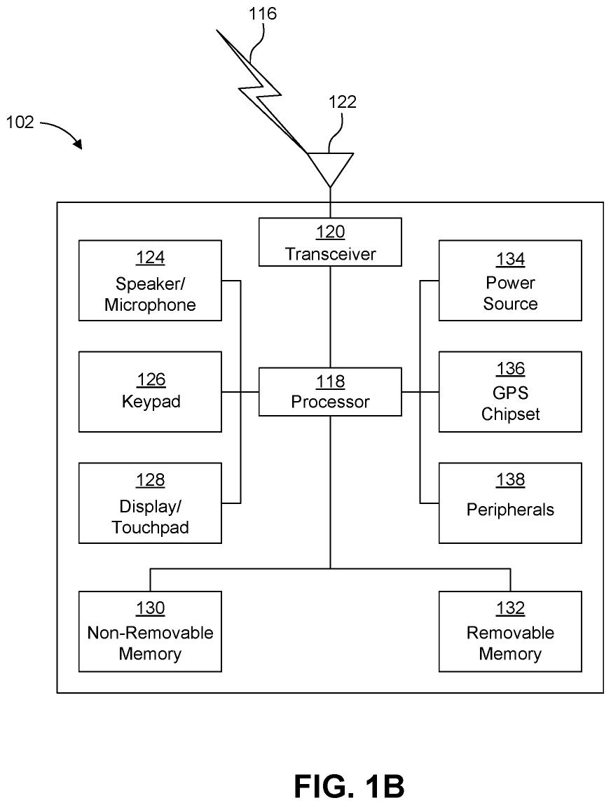

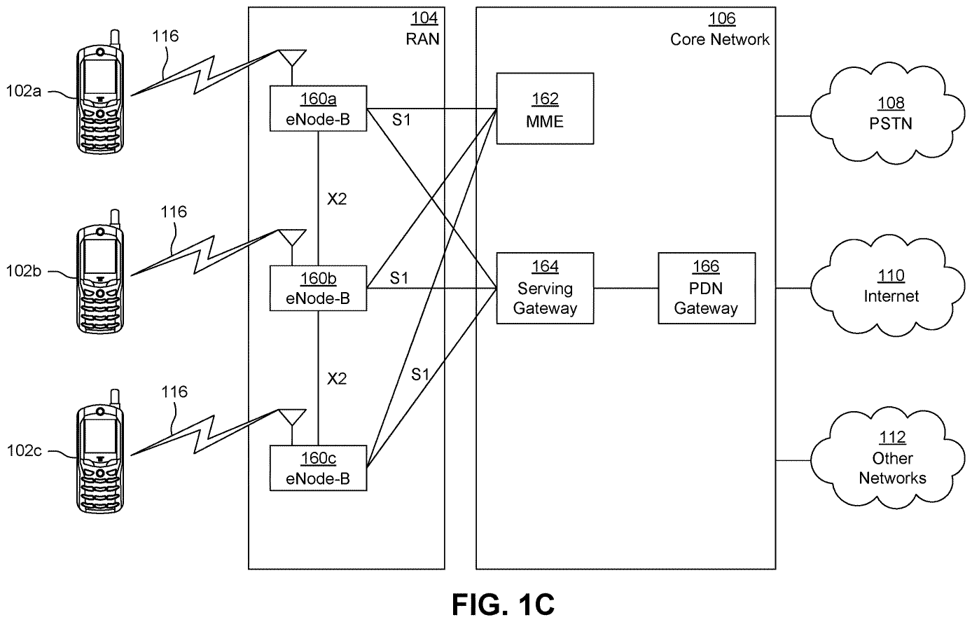

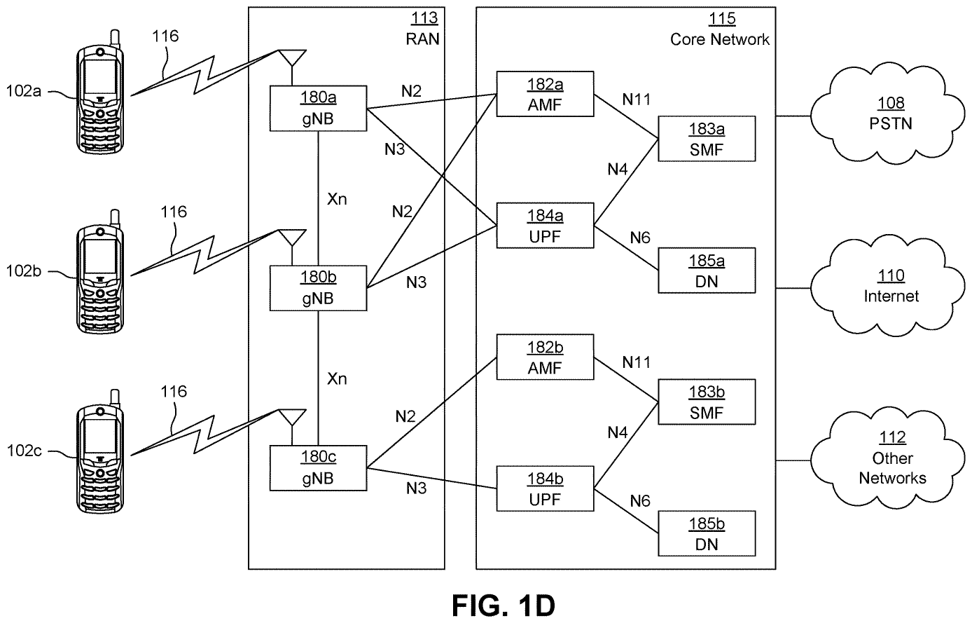

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following acronyms and abbreviations may be used herein:
5GS 5G System
ADU Application Data Unit
AF Application Function
AI/ML Artificial Intelligence/Machine Learning
API Application Programing Interface
AS Application Server
ATSSS Access Traffic Steering, Switching, Splitting
ATSSS-LL ATSSS-Lower Layer
CDN Content Delivery Network
DL Downlink
FEC Forward Error Correction
GTP-U Generic Tunneling Protocol User Plane
ID Identifier
IE Information Element
MA-PDU Multi-Access PDU
MOQ Media Over QUIC
MPQUIC Multipath QUIC
MPTCP Multipath TCP
MTU Maximum Transmission Unit
N4 N4 Interface in 5GS
NACK Negative Acknowledgement
PCC Policy and Charging Control
PDU Protocol Data Unit
PLR Packet Loss Rate
PMF Performance Measurement Functionality
PSDB PDU Set Delay Budget
PSER PDU Set Error Rate
PSII PDU Set Integrated Indication
QoE Quality of Experience
QoS Quality of Service
QUIC The QUIC protocol
RAN Radio Access Network
RAT Radio Access Technology
RTP Real-Time Protocol
SDAP Service Data Adaptation Protocol
SMF Session Management Function
UE User Equipment
UL Uplink
UPF User Plane Function
URSP UE Route Selection Policy
XR Extended Reality

As described herein, the terms AS and AF may be used interchangeably.

As described herein, the terms XR-aware and PDU set-aware may be used interchangeably.

PDU sets were introduced in 5GS to enable support of XR traffic (e.g., in mobile networks). PDU sets and the PDU set supporting features (e.g., in mobile networks) may be used to address other types of traffic, such as high-throughput, low-latency traffic.

In certain representative embodiments, a network entity (e.g., a UPF 184) may perform any of the following. For example, a UPF 184 may receive an N4 session establishment/modification request. The N4 session establishment/modification request may include a PDU set-aware steering mode. The request may include associated parameters, such as configuration information, for the PDU set-aware steering mode. The UPF 184 may configure a steering functionality with a PDU set-aware steering mode. The UPF 184 may configure associated parameters for the PDU set-aware steering mode. The UPF 184 may receive at least one PDU associated with a PDU set and one or more PDU set IEs. The UPF 184 may obtain at least one PDU set IE associated with a (e.g., respective) PDU. The UPF 184 may use one or more of the PDU set IEs, associated parameters, and/or the PDU set-aware steering mode to select an access for at least one (e.g., the respective) PDU. The UPF 184 may send the at least one (e.g., the respective) PDU over the selected access.

In certain representative embodiments, a WTRU 102 may receive information indicating “network support for PDU set-aware steering” from the network. The WTRU 102 may use the indication of network support for PDU set-aware steering to determine and/or specify PDU set-aware steering capabilities. The WTRU 102 may trigger establishment (e.g., trigger) of an (e.g., XR) application session. The WTRU 102 may determine to trigger the establishment of a MA-PDU session. The WTRU 102 may send a PDU Session establishment/modification request. The PDU Session establishment/modification request may include information specifying one or more PDU set-aware steering capabilities. The WTRU 102 may receive a PDU session establishment/modification response. The PDU session establishment/modification response may include information indicating one or more ATSSS rules, which may include or otherwise indicate a PDU set-aware steering mode. The ATSSS rules may include associated parameters (e.g., configuration information) for the PDU set-aware steering mode. The WTRU 102 may configure steering functionality with a PDU set-aware steering mode. The WTRU 102 may (e.g., application executed by the WTRU 102 may cause the WTRU 102 to) send at least one PDU associated with a PDU set and one or more PDU set IEs. The WTRU 102 may use at least one of the PDU set IEs, PDU set-aware steering mode and/or associated configuration information to select the access for the at least one PDU. The WTRU 102 may send the at least one PDU over the selected access.

### ATSSS

For example, many WTRUs may be capable of both 3GPP access and non-3GPP access. This capability provides flexibility to network operators in determining which access to use for a service data flow. Access Traffic Steering, Switch and Splitting (ATSSS) was introduced in 3GPP Release 16 and further enhanced in Release 17 to take advantage of this flexibility.

In certain representative embodiments, ATSSS may be based (e.g., rely) on setting up a Multi-Access PDU (otherwise referred to as MA PDU or MA-PDU herein) session, which is a PDU session where traffic from a service data flow may be sent over one access or the other, or over both accesses (e.g., 3GPP access and non-3GPP access). Further extensions of ATSSS may include accesses which use different RATs and/or a same RAT. Further extensions may support more than two accesses. The methods and procedures described herein may apply to ATSSS and further extensions. We may herein use interchangeably use the terms access, access link and/or path to designate, for example, a single path through one radio access link.

ATSSS relies on steering functionality, which is logic applied in the WTRU 102 for uplink, and in the UPF 184 for downlink, to enable the switching, steering, and/or splitting. For example, two steering functionalities have been standardized: (1) MPTCP which may be used for TCP traffic and (2) ATSSS-LL which may be used for Ethernet, TCP, and/or UDP traffic. A third functionality is currently being defined: MPQUIC which may be used for UDP traffic.

Steering Modes are mode of operations of these steering functionalities. For example, currently defined steering modes include: (1) Active-Standby, (2) Smallest Delay, (3) Load Balancing, (4) Priority based, and (5) Redundant. A WTRU 102 and UPF 184 may be provided with rules to tell them which steering mode to use (e.g., for a given SDF), as well configuration details for the respective steering mode. In the priority based steering mode, for example, the traffic of an SDF is steered over the high priority access, until this access is congested, at which point the traffic is split over the two accesses.

In certain representative embodiments, transmission over multiple accesses may also involve device-to-device communications. For example, a MA-PDU session may be used for multi-path transmission over a combination of a direct Uu interface (e.g., usual connection through the network) and a Layer-3 WTRU-to-Network Relay with a N3IWF.

### XR Traffic Handling by Wireless Networks and PDU Sets

For example, challenges may exist for wireless networks to carry media flows, such as for applications with high-throughput and low latency requirements (e.g., video conferencing and/or XR). Wireless networks may implement techniques to improve network capacity and energy efficiency, as well as reduce the impact of packet losses on user experience. For example, wireless networks, such as 5G, may handle groups of packets based on how critical they are to the user experience.

In certain representative embodiments, a group of data packets may include application data units (ADUs) that are handled together (e.g., decoded) by the application. A set of packets including ADUs may be referred to as a “PDU set”. For example, a PDU set may correspond to the PDUs carrying a single (e.g., complete) Network Application Layer (NAL) unit.

To support high-throughput low-latency media flows, the network (e.g., RAN) may perform differentiated and/or integrated QoS handling of XR traffic. This handling may include prioritizing PDU sets over others in cases of congestion. The network may use the fact that ADUs can depend on other ADUs to be handled or decoded by the application (e.g., P-frames depend on I-frames, and/or higher layers depend on lower layers). The network may also selectively drop data packets that depend on an already lost ADU. The network can limit wake-up time (e.g., of radios) to transmit and receive data. For example, the packet scheduler (e.g., in RAN nodes) and/or WTRUs may synchronize their transmission and listening times using information on the size and periodicity of traffic bursts, as well as information on delay budget and expected jitter (e.g., specific to the application).

The RAN may perform differentiated and/or integrated QoS handling of XR traffic based on PDU Set IEs associated with a flow and/or PDU sets inside this flow. For example, PDU Set IEs may include PDU Set QoS parameters that are received via the control plane and/or PDU Set information that was received via the user plane. For downlink traffic, for example, PDU set information may be sent by the UPF 184 to the RAN node via a GTP-U header of a user plane packet. For uplink traffic, for example, PDU set information may be provided by a WTRU-executed application through the SDAP interface.

In certain representative embodiments, PDU set information may include and/or refer to any of a PDU set ID, a PDU set start and/or end indication, a PDU sequence number, a PDU set size, a PDU set importance, PDU set dependence, and/or PDU set layer.

For example, a PDU set ID may be information (e.g., an IE) which is an identifier of a PDU set. A PDU set ID may (e.g., uniquely) identify the PDU set within the flow, such as (e.g., at least) for a duration corresponding to the transmission time of PDUs between a sender and a receiver. This IE may be a numerical ID, a timestamp, or other identification information.

For example, a start or end of a PDU Set indication may be information (e.g., IEs) that identify the first or last PDU(s) of a PDU set.

For example, a PDU sequence number (e.g., within a PDU Set) may be information (e.g., an IE) that identifies a PDU within a PDU set. As an example, sequence numbers may be set as numerical IDs starting at 0 for the first PDU and incremented by 1 for each PDU in the set.

For example, a PDU set size may be information (e.g., an IE) that includes (e.g., indicates) a total number of PDUs, a cumulative length of all the PDUs in the set, and/or the cumulative length of all PDU payloads (e.g., transport payloads) in the PDU set. For example, the cumulative length may be described as a number of bytes.

For example, a PDU set importance may be information (e.g., an IE) which includes a numerical value indicative of an importance level of a PDU set within a service flow (e.g., from highest priority value “0” to lowest priority value “255”). The RAN may use the importance information for a PDU set level packet discarding, such as in the presence of congestion. The PDU set importance may be different from the QoS flow priority level, since the QoS flow priority level applies to the whole flow, while the PDU set importance may be applied to an individual PDU set. Within a QoS flow with a given priority level, it is possible to transmit multiple PDU sets, each with its own PDU set importance. PDU set importance therefore enables applying a more granular level of service within a single QoS flow. For example, in cases of congestion, PDU set importance makes it possible to selectively drop less important traffic within a single QoS flow.

For example, PDU set dependence information may be information (e.g., an IE) that includes an indication that a PDU set is dependent or independent. PDU set dependence information may indicate (e.g., include) the IDs of PDU sets that a respective PDU depends upon. PDU set dependence information may indicate (e.g., include) the IDs of PDU sets that depend on a respective PDU set.

For example, a PDU set layer may be information (e.g., an IE) that indicates a temporal and/or spatial layer that the ADU information transported in a respective PDU set belongs to.

In certain representative embodiments, PDU set QoS parameters may include and/or refer to any of PDU set error rate, PDU set delay budget, PDU set integrated indication, and/or burst periodicity. For example, PDU set QoS parameters may refer to a set of parameters to configure the QoS handling of a flow.

For example, a PDU set error rate may be information (e.g., an IE) of values that correspond to error rates applicable to PDU sets (e.g., where a PDU set loss corresponds to an event where at least a PDU of the set could not be transmitted successfully). The PDU Set Error Rate may be used to configure the acceptable error rate for PDU sets of a service flow and/or QoS flow in the RAN.

For example, a PDU set delay budget may be information (e.g., an IE) of a value corresponding to the acceptable delay for transmitting a full PDU set (e.g., from the reception of the first PDU of the set, to the transmission of the last PDU of the set). The PDU Set Delay Budget may be used to configure the delay budget for a service flow and/or QoS flow in the RAN.

For example, PDU Set Integrated Indication (PSII) may be information (e.g., an IE) that indicates whether all PDUs of the set are needed (e.g., required) by the application.

For example, a burst periodicity may be information (e.g., an IE) of a value that designates the period of a data burst for a respective flow (e.g., transmission period for consecutive independent frames in a video stream or for a group of pictures).

For example, the use of a single access path for XR traffic may lead to poor QoE when the link experiences congestion. The use of multiple paths (e.g., using ATSSS) may help to resolve this issue. However, existing ATSSS steering modes are not aware of the importance of PDU sets within a XR flow. This can lead to steering issues.

For example, sending PDUs from higher importance PDU sets over an access link experiencing transmission errors may result in the receiver potentially being unable to decode a high-importance ADU (e.g., an I-frame) and any dependent data units (e.g., P-frames and/or B-frames). This may lead to a high impact on user QoE (e.g., frozen picture and/or video artifacts). For example, sending important PDU sets using a best link could reduce this impact.

With some steering modes (e.g., load balancing) PDUs from a same PDU set may often be sent over different paths. In cases where one of the links experiences transmission errors, this may result in spreading PDU losses across PDU sets, while it could be more beneficial to concentrate PDU losses in fewer PDU sets. Spreading PDU losses across PDU sets can result in a higher probability of losing high importance PDU sets, which may have a high impact on QoE.

To enable wireless networks (e.g., 5GS) to support XR traffic awareness and handling (e.g., PDU Sets) using ATSSS procedures (e.g., MA PDU Session) to ensure a same or better QoE than when using a single access PDU Session, new modes of operation for ATSSS may need to be defined, such as ATSSS modes that take into account PDU sets and PDU Set IEs.

In certain representative embodiments, procedures are described with respect to XR traffic. In other representative embodiments, these procedures may be applied to any (e.g., all) instances of transmissions which involve multi-access of PDU set-supporting traffic, such as any combination of sessions over 2 or more accesses of 3GPP and non-3GPP links, sessions between WTRUs over sidelinks and through the network, sessions over 2 or more accesses involving WTRU relays, and/or sessions combining those characteristics.

### PDU Set-Aware Steering

In certain representative embodiments, a network entity, such as a network entity providing a UPF 184, may perform procedures for DL traffic using one or more PDU set-aware steering modes.

In certain representative embodiments, a WTRU 102 may perform procedures for UL traffic using one or more PDU set-aware steering modes.

### PDU Set-Aware Steering Mode for DL Traffic

In certain representative embodiments, a network entity (e.g., a UPF 184) may receive an N4 session establishment (or modification) request which includes information indicating a PDU set-aware steering mode. The request may include parameters (e.g., configuration information) associated with the PDU set-aware steering mode. The network entity may configure a steering functionality with the PDU set-aware steering mode and/or associated parameters. The network entity may receive a PDU associated with a PDU set and PDU set IEs. The network entity may obtain at least one PDU set IE associated with the PDU. The network entity may use any of the PDU set IE(s), the associated parameters, and/or the PDU set-aware steering mode to select access (e.g., access path) for the PDU.

### PDU Set-Aware Steering Mode for UL Traffic

In certain representative embodiments, a WTRU 102 may receive information indicating network support for PDU set-aware steering. The WTRU 102 may trigger establishment of an XR application session. The WTRU 102 may determine to trigger establishment of a MA-PDU session. The WTRU 102 may send a PDU session establishment or modification (e.g., message). For example, the WTRU 102 may include information indicating and/or specifying PDU set-aware steering capabilities. For example, the PDU set-aware steering capabilities may be determined (e.g., by the WTRU 102) based on network support for PDU set-aware steering. The WTRU 102 may receive a PDU session establishment (or modification) response (e.g., message). For example, the response may include information indicating one or more ATSSS rules including a PDU set-aware steering mode and associated (e.g., configuration) information. The WTRU 102 may configure steering functionality based on the PDU set-aware steering mode. The WTRU 102 (e.g., XR application) may send a PDU which is associated with a PDU set and at least one PDU set IE. The WTRU 102 may use any of the PDU set IE(s), the PDU set-aware steering mode and/or the associated (e.g., configuration) information to select access (e.g., access path) for the PDU.

### PDU Set-Aware Steering Modes

We define herein new “PDU set-Aware” (or “XR-Aware”) steering modes, which are steering modes that use differentiated/integrated handling IEs including PDU Set Information and/or PDU set QoS parameters, to determine on which access to send a PDU. In some cases, for simplicity herein we use the term PDU Set Information to designate both PDU Set Information and PDU set QoS parameters. A WTRU 102 or UPF 184 configured to use a PDU set aware steering mode may perform steering determinations for each PDU, and/or for each PDU set (i.e., in some instances, e.g., depending on the PDU set aware steering mode algorithm used, the steering determination may apply for a single PDU, while in other instances, the steering determination may apply for all PDUs in a PDU set).

### PDU Set IEs for PDU Set-Aware Steering Modes

In certain representative embodiments, a PDU set-aware steering mode may use any of the following PDU set information (e.g., IEs): PDU Set ID Start/End of a PDU Set indication, PDU Sequence Number within a PDU Set, PDU Set size, PDU Set Importance, PDU Set Error Rate, PDU Set Delay Budget, PDU Set Integrated Indication, Burst information (e.g., periodicity), PDU set dependence information, and/or PDU set layer.

In certain representative embodiments, PDU set information (e.g., IEs) may include a PDU payload modality. For example, PDU payload modality may (e.g., explicitly) designate a modality (e.g., audio, video, haptics, data), or designate an abstract modality (e.g., mode 1, 2, etc.). A UPF 184 and/or WTRU 102 may, such as based on traffic analysis or proxy application logic, associate a PDU or PDU set with a modality. For example, a MOQ relay in a UPF 184 and/or a WTRU 102 may classify PDUs from audio tracks as “audio” modality, video tracks as “video” modality, etc.

In certain representative embodiments, PDU set information (e.g., IEs) may include forward error correction information. For example, PDU set information may include a FEC indication (e.g., true if FEC is used on this PDU set or flow). For example, PDU set information may include a FEC symbol type (e.g., indicating if a PDU contains a source or repair symbol). For example, PDU set information may include information indicating a FEC algorithm and its parameters (e.g., associating a FEC algorithm and parameters with a flow or PDU set). For example, PDU set information may include any of these IEs which may be used to associate information about FEC with a PDU, PDU set, service flow and/or QoS flow. Any of these IEs may be used by the network (e.g., RAN) to optimize transmission scheduling (e.g., no need to send a repair symbol if all source(s) symbols were successfully transmitted).

In certain representative embodiments, any of the PDU set information (e.g., IEs) may be signaled on the user plane and/or on the control plane. A WTRU 102 and/or a UPF 184 may obtain PDU Set information corresponding to a specific PDU set or PDU.

For example, user plane PDU Set IEs may be obtained by a WTRU 102 from an application directly (e.g., the application may provide PDU set IEs in a library function call). For example, user plane PDU Set IEs may be obtained by a WTRU 102 from an inspection (or proxy) function (e.g., a function that parses RTP headers to extract PDU set IEs, or a MOQ proxy that extracts PDU set IEs).

For example, user plane PDU Set IEs may be obtained by a UPF 184 from an inspection (or proxy) function (e.g., a function that parses RTP headers to extract PDU set IEs, or a MOQ proxy that extracts PDU set IEs). Other methods may be used, such as a CDN node (e.g., proxy) on the path may extract metadata from the flow and provide the metadata to the UPF 184 in a tunnel header or another (e.g., IP option, UDP option) header.

For example, control plane PDU Set IEs may be configured in the PCC rules, and provided by an SMF 183 (e.g., to a WTRU 102 via URSP rules or ATSSS rules and/or to a UPF 184 via N4 rules). For example, control plane PDU Set IEs may include any of PSER, PSDB, burst information, and/or PSII. As another example, FEC IEs may be obtained from the protocol information configurated in a PCC rule as well.

To use PDU Set IEs, a WTRU 102 and/or UPF 184 using a PDU set-Aware steering mode may need information measured in real time and reported between the UPF 184 and the WTRU 102 (e.g., using the PMF protocol). For example, (e.g., new) measurements exchanged over PMF may include any of: PDU Set loss, PDU Set latency, and/or burst jitter. Any of these measurements may be presented as tuples (e.g., measurement, PDU Set IE) associating a measurement with a given PDU Set IE, such as “PDU Set Importance”, “Independent PDU Set”, “Dependent PDU Set”, etc. These measurements (either generally or per-PDU set-IE) may be used by a WTRU 102 or UPF 184 as input to adjust the PDU set-Aware steering mode operation. For example, if independent PDU sets loss is higher than a threshold or is not lower than dependent PDU set loss, then the WTRU 102 or UPF 184 may select a different steering algorithm (e.g., set of steering algorithms) to steer the traffic. Further embodiments and examples are described herein.

### Partially XR-Aware MA-PDU Session

In certain representative embodiments, a “partially XR-aware” MA-PDU session may refer to a MA-PDU session which is setup over different accesses supporting differentiated and/or integrated QoS handling for XR traffic (e.g., PDU set-aware access), and/or accesses not supporting such handling (e.g., non-PDU set-aware access). For example, a first base station (e.g., a gNB) may be PDU set-Aware (e.g., capable of providing PDU set-aware access). For example, a second base station (e.g., a Wi-Fi access point) may not be PDU set-Aware (e.g., not capable of providing PDU set-aware access).

In certain representative embodiments, PDU-set-awareness of access types, or specific access nodes, may be part of the operator's network configuration, a SMF local configuration, and/or may be provided by RAN nodes to an SMF 183 as part of their capabilities.

During operation, a WTRU 102 and/or UPF 184 may make a steering determination based on a steering mode configuration. For example, a steering mode configuration may associate actions (e.g., forwarding of a PDU) with the PDU set-Awareness (e.g., PDU set-aware or non-PDU set-aware) of an access.

In certain representative embodiments, a WTRU 102 and/or a UPF 184 may transmit at least one PDU according to the “PDU set-Awareness” of the selected access. For example, a selected access may be PDU Set-Aware, and the WTRU 102 (or UPF 184) may send one or more PDUs along with PDU set IEs. For example, a selected access may be non-PDU Set-Aware, and a WTRU 102 (or UPF 184) may send one or more PDUs without PDU set IEs. In an example, a XR-aware MA-PDU session may be configured to transmit PDU sets over PDU set-Aware access (e.g., unless congested or down), and then fallback (e.g., due to congestion or downed-access) to a non-PDU set-Aware access.

In certain representative embodiments, a UPF 184 may anchor an MA-PDU Session. The MA-PDU Session may be associated with a first RAT link (e.g., one NG-RAN access link) and a second RAT link (e.g., one non-3GPP access link).

For example, a UPF 184 may detect or be configured with information indicating whether a NG-RAN access link is “PDU Set Aware” or not. The UPF 184 may detect or be configured with information indicating whether a non-3GPP access link is “PDU Set Aware” or not. For example, one access link may be “PDU Set Aware” and the other access link may not be “PDU Set Aware”, and the UPF 184 may determine to not apply steer traffic that is part of a PDU Set without splitting the traffic (e.g., forward all PDU Sets over the PDU Set Aware access link) and to only apply traffic steering policies that split the traffic to the traffic that is not part of a PDU Set. For example, one advantage to doing this may be that a single node (e.g., a NG-RAN node) will receive all the PDUs within each PDU set and will be able to apply PDU Set specific features (e.g. selective PDU dropping and/or PDU Set dropping) and the non-PDU Set traffic may still be able to benefit from the UPF 184 splitting traffic over two links.

In certain representative embodiments, a WTRU 102 may have an established MA-PDU Session. The MA-PDU Session may be associated with a first RAT link (e.g., one NG-RAN access link) and a second RAT link (e.g., one non-3GPP access link).

For example, a WTRU 102 may detect or be configured with information that indicates whether a NG-RAN access link is “PDU Set Aware”. The WTRU 102 may detect or be configured with information that indicates whether a non-3GPP access link is “PDU Set Aware”. For example, one access link may be “PDU Set Aware” and the other access link may not be “PDU Set Aware”, and the WTRU 102 may determine to steer the traffic that is part of a PDU Set without splitting the traffic (e.g., forward all PDU Sets over the PDU Set Aware access link) and to only apply traffic steering policies that split the traffic to the traffic that is not part of a PDU Set. For example, one advantage to doing this may be that a single node, e.g. an NG-RAN node, will receive all the PDUs within each PDU set and will be able to apply PDU Set specific features (e.g. selective PDU dropping and PDU Set dropping) and the non-PDU Set traffic will still be able to benefit from the UPF 184 splitting traffic over two links.

### Representative Steering Algorithms for PDU Set-Aware Steering Modes

In certain representative embodiments, a WTRU 102 and/or UPF 184 may have one or more components implementing one or more of the following algorithms (e.g., in combination). For example, a WTRU 102 and/or UPF 184 may determine a PDU set-Aware steering mode which may be associated with a set of steering algorithms. For example, a WTRU 102 and/or UPF 184 may determine a PDU set-Aware steering mode and further determine a set of steering algorithms to use for the determined PDU set-aware steering mode.

In certain representative embodiments, combinations of steering algorithms may be implemented at multiple levels. For example, combinations of steering algorithms may be implemented at (e.g., any) two levels. At a first level, combinations of steering algorithms may be assembled into a single steering mode. For example, the single steering mode may include logic (e.g., based on PDU set information) to determine which algorithm(s) to apply for a given PDU. At a second level, a policy configuration may include at least one PDU set information-based criterion to select one steering mode from among multiple steering modes. For example, both levels of combination may be used (e.g., concurrently or not) within a same network.

For example, the following algorithm descriptions include decisions, which may be based on PDU set information, logic internal to a steering mode, and/or processing of PDU set information-based criteria in a policy configuration.

In an example of a first level combination, a (e.g., single) steering mode may be used by a WTRU 102 and/or a UPF 184 for a traffic flow (e.g., a media flow). The steering mode may use redundant transmission over multiple (e.g., both) accesses for high importance PDUs. The steering mode may use a lowest RTT access for (e.g., any) other PDUs. For example, the first level combination may be based on a configuration from PCC rule information (e.g., a single PCC rule).

In an example of a second level combination, multiple PCC rules (or multiple IEs within a PCC rule) may be associated with (e.g., match) a traffic flow (e.g., a media flow). A first PCC rule (or a first IE in the PCC rule) may match the traffic flow (e.g., using a traffic flow descriptor with the appropriate IP addresses and ports), and may match (or specify) a highest PDU set importance. The first PCC rule (or first IE in the PCC rule) may indicate a redundant steering mode. A second PCC rule (or second IE in the PCC rule) may match the traffic flow (e.g., using IP addresses and ports) and may not specify a PDU set importance. In this example, the second PCC rule (or second IE in the PCC rule) has a lower priority than the first PCC rule. The second PCC rule (or second IE in the PCC rule) is therefore determined as a match for any (e.g., all) PDU set importances not matching or specified in the first PCC rule (or first IE in the PCC rule). The second PCC rule (or second IE in the PCC rule) may include information indicating a lowest RTT steering mode. The two steering modes indicated by the PCC rule(s) may both be used by the WTRU 102 and/or UPF 184 for the traffic flow, and the resulting steering of PDUs may be the same as in the preceding example of the first level combination.

In certain representative embodiments, an “access” may be determined and/or specified in a steering algorithm, such as by using an access type and/or access characteristic to identify the access. For example, an access type may be indicated to be any of one or more of 3GPP, non-3GPP, Relay-UE-based, PDU set-Aware, and/or non-PDU set-Aware. For example, an access characteristic may be indicated to be any of cost, shared, and/or dedicated among other access characteristics.

For example, different steering algorithms and/or combinations thereof may be considered, selected, used and/or applied for PDUs (e.g., by a WTRU 102 and/or a UPF 184). Each algorithm may require configuration information. The configuration information may be associated with any of QoS Flow, PDU Session, PDU set, and/or SDF. The configuration information may indicate which algorithm to apply. The configuration information may include a set of configuration parameters that may be used to execute the algorithm. For example, a UPF 184 may receive the configuration information from a SMF 183 in an N4 message. For example, a WTRU 102 may receive the configuration information from the SMF 183 in a NAS-SM message.

In certain representative embodiments, an importance-based steering algorithm may be executed by a WTRU 102 and/or a UPF 184. When an importance-based steering algorithm is selected or otherwise used, any (e.g., each) importance level may be associated with a steering mode algorithm and related parameters, where the steering modes can be selected from among existing ones such as Active-Standby, Smallest Delay, Load Balancing, Priority-based, Redundant, and/or other (e.g., new) steering mode algorithms as described herein. For example, any PDU sets with high importance (e.g., importance value “0”) may be transmitted redundantly over multiple access, while other PDU sets (e.g., importance value other than “0”) may be load balanced across each access. For example, any PDU sets with high importance may be associated with a high priority access (e.g., the high priority access may be selected as the most stable access link). Other (e.g., non-high importance) PDU sets may be steered towards the access with a smallest-delay.

For example, importance-based steering may be useful to allocate more network resources and/or prioritize a particular access (e.g., most reliable access) to more important PDUs (e.g., base layer or independent frames). This may improve QoE.

For example, configuration information that may be used to execute importance-based steering may include a set of tuples (e.g., importance value(s), steering algorithm), which associate a steering algorithm with one or more importance values.

For example, a WTRU 102 and/or a UPF 184 may determine that an importance level is associated with a PDU. The WTRU 102 or UPF 184 may use a determined importance level to determine what steering mode to apply to the PDU. Applying a steering mode for a PDU may include determining what access network to send a PDU to.

In certain representative embodiments, an importance-based access selection algorithm may be executed by a WTRU 102 and/or a UPF 184. When an importance-based access selection algorithm is selected, any (e.g., each) importance level may be associated with an access. In an example, to steer a PDU, the WTRU 102 or UPF 184 may use a PDU set importance level associated with the PDU set of the PDU and looks it up in an importance/access association table. The importance/access association table may be created based on configuration information (e.g., obtained from SMF 183, which gets it from a PCC rule). For example, in a cellular-Wi-Fi MA-PDU scenario, high importance PDU sets may be associated with cellular access, and other (e.g., non-high importance) PDU sets may be associated with Wi-Fi access. When an access is or becomes congested, the traffic on the congested access may start using another access.

For example, importance-based access selection may be useful to steer the most important traffic through the most suitable access (e.g., an access known to be more stable, or with a pattern of transmission error better suited for the application to recover application data from incomplete PDU sets).

For example, the configuration information that may be used to execute importance-based access selection may include a set of tuples (e.g., importance value(s), access), which associate a steering algorithm and/or access type with one or more importance values.

In certain representative embodiments, a complete PDU set access selection algorithm may be executed by a WTRU 102 and/or a UPF 184. After a complete PDU set access selection algorithm is selected, when a new PDU is available for steering (e.g., a new PDU needs to be transmitted), the WTRU 102 and/or UPF 184 may determine an access to use for transmission, which may (e.g., will) be applicable for any (e.g., all) other PDUs in the same PDU set. The access selection itself may use other considerations (e.g., load balancing, smallest delay, etc.). Once the access is selected for the first PDU of a PDU set that is received, the WTRU 102 or UPF 184 may maintain some state information that associates this PDU set with the selected access. When a new PDU associated with the same PDU set is available to transmit, the WTRU 102 or UPF 184 may retrieve the state information associated with the PDU set, and if such state information is found, select the access saved in the state information to send the PDU. For example, the state information may be released when the last PDU of the set is transmitted, or when a timeout elapses without a PDU from the set being transmitted.

For example, complete PDU set access selection may be useful in the presence of transmission error patterns where successive or close PDUs are lost, to increase the chances that a group of lost PDUs will belong to the same PDU set. This can help minimize PDU set error, and contribute to increasing QoE. In an example, the WTRU 102 or UPF 184 may load balance complete PDU sets between accesses, such as by using a PDU set size to evaluate the effect of each PDU set on per-access load.

For example, the configuration information that may be used to execute the complete PDU set access selection algorithm may include information indicating to transmit all PDUs of PDU sets on a same access.

In certain representative embodiments, a Split PDU set access selection algorithm may be executed by a WTRU 102 and/or a UPF 184. After a Split PDU set access selection algorithm is selected, when a new PDU is available for steering (e.g., a new PDU needs to be transmitted), the WTRU 102 and/or UPF 184 may determine multiple accesses to use for transmission of the PDU set that this PDU belongs to. The WTRU 102 or UPF 184 may manage (e.g., create and maintain) local state information related to the PDU set ID, indicating how to steer PDUs from this set to multiple accesses (e.g., steer PDUs with odd sequence number to a first access, and PDUs with even sequence number to a second access).

For example, split PDU set access selection may be useful when it is preferable to spread errors across PDU sets (e.g., to maximize the odds of being able to reconstruct an ADU from a PDU set, such as by using FEC). In an example, a WTRU 102 or UPF 184 may look up FEC information (e.g., IEs) associated with a PDU, PDU set, and/or flow, and determine to split PDU set access if FEC is used, or to use complete PDU set access selection if FEC is not used.

For example, the configuration information that may be used to execute the split PDU set access selection algorithm may include an indication of a percentage, or ratio, of the PDUs from a PDU Set that should be transmitted on each access.

In certain representative embodiments, a PDU set-specific access selection algorithm may be executed by a WTRU 102 and/or a UPF 184. When a PDU set-specific access selection algorithm is selected, an access (or a set of accesses associated with a selection algorithm) may be selected for use with PDUs belonging to one or more PDU sets and/or an access (or algorithm) may be selected for use with PDUs not belonging to a PDU set (e.g., the one or more PDU sets). When a new PDU is available for steering (e.g., a new PDU needs to be transmitted), the WTRU 102 or UPF 184 may determine whether the PDU belongs to a PDU set (e.g., if there is associated PDU set information) or not. Based on whether the PDU belongs to the PDU set, the WTRU 102 (or UPF 184) may steer the PDU using the appropriate selected access (or algorithm). For example, the WTRU 102 (or UPF 184) may select an algorithm to be applied to the PDU, such as from among any of load balancing, smallest delay, complete PDU set access selection, split PDU set access selection, importance-based access selection, or others described herein.

For example, PDU set-specific access selection may be useful to support MA-PDU sessions over a mix of accesses supporting differentiated and/or integrated QoS handling of XR traffic, and accesses not supporting this feature.

For example, PDU set-specific access selection may be useful to provide a different level of service, such as for control information carried along with media data in the user plane.

For example, the configuration information that may be used to execute PDU set-specific access selection algorithm may include a list of accesses and/or steering algorithms for sending PDU sets, and/or a list of access and/or steering algorithms for sending non-PDU set PDUs.

In certain representative embodiments, a PDU set size-based access selection algorithm may be executed by a WTRU 102 and/or a UPF 184. After a PDU set size-based access selection algorithm is selected, when a new PDU is available for steering (e.g., a new PDU needs to be transmitted), the WTRU 102 (or UPF 184) may retrieve PDU set information associated with the PDU and obtains a PDU set size. For example, the WTRU 102 or UPF 184 may steer the PDU towards a first access based on the PDU set size being below a (e.g., configured) threshold, otherwise the WTRU 102 or UPF 184 may steer the PDU towards a second access. For example, the first and second accesses may be statically configured, or may be determined based on current measurements. As an example, the second access may be the access with a lowest PDU error rate (e.g., currently or within a time interval).

For example, PDU set size-based access selection may be useful to improve the PDU set error rate of (e.g., larger) PDU sets, by directing the PDU sets towards an access experiencing a low PDU error rate.

For example, the configuration information that may be used to execute PDU set size-based access selection algorithm includes a set of tuples (e.g., PDU set size range, access, and/or algorithm) which associate an access and/or steering algorithm with a range of PDU set sizes.

In certain representative embodiments, a Modality-based access selection algorithm may be executed by a WTRU 102 and/or a UPF 184. For example, the modality may refer to the modality of a PDU payload. After a Modality-based access selection algorithm is selected, an access (or a set of accesses associated with a selection algorithm) may be selected for use with PDUs associated with a given modality. When a new PDU (e.g., associated with PDU set information) is available for steering, the WTRU 102 and/or UPF 184 may retrieve the associated modality of the new PDU, and select the appropriate selected access and/or algorithm based on the associated modality.

For example, modality-based access selection may allow a WTRU 102 and/or UPF 184 to apply different steering mode processing per modality, such as where the modalities are associated with the same 5-tuple (e.g., when the modalities are multiplexed inside a QUIC connection). For example, the 5-tuple may include a (e.g., fixed) set of five values for indicating a source IP address and port number, a destination IP address and port number and a transport protocol, which is typically UDP in this case. For example, audio traffic may be directed to an access with low delay and/or high reliability. For example, video traffic may be directed using other steering algorithms (e.g., importance-based access selection).

For example, the configuration information that may be used to execute Modality-based access selection algorithm may include a set of tuples (e.g., modality, access and/or steering algorithm) which associate an access or steering algorithm with a range of PDU set sizes. As an example, a modality IE (e.g., audio, video, haptics, data, mode 1, mode 2, etc.) may be added to the traffic filter of policy rules (e.g., PCC rules, URSP rules, QoS parameters, N4 rules, ATSSS rules), such that different PDU set IEs may be associated with different modalities.

In certain representative embodiments, a PSII-based access selection algorithm may be executed by a WTRU 102 and/or a UPF 184. When a PSII-based access selection algorithm is selected, an access (or a set of accesses associated with a selection algorithm) may be selected for use with any PDUs belonging to PDU sets with a PSII associated therewith (e.g., set), and/or an (e.g., another different) access or selection algorithm may be selected for use with any PDUs belonging to a PDU set with PSII not associated therewith (e.g., set). When a new PDU (e.g., associated with PDU set information) is available for steering, the WTRU 102 and/or UPF 184 may retrieve the associated PSII, and select an appropriate access or selection algorithm based on (e.g., the presence or absence of) PSII.

For example, PSII-based access selection may be useful to improve the probability to successfully deliver a PDU set with PSII set, since such a PDU set may be useless to a receiving application if a PDU of the PDU Set is not successfully delivered. Thus, it may be desirable to give the same treatment (e.g., use the same access network) to all the PDUs of the PDU set. For example, a PDU set with a PSII set may be associated with redundant transmission.

For example, the configuration information that may be used to execute the PSII-based access selection algorithm may include a list of accesses and/or algorithms for sending PDUs associated with any PSII PDU sets, and/or a list of accesses and/or algorithms for sending PDUs associated with any non-PSII PDU sets.

In certain representative embodiments, a PSER estimation-based access selection algorithm may be executed by a WTRU 102 and/or UPF 184. When a PSER estimation-based access selection algorithm is selected, when a first PDU of a PDU set is available for steering, the WTRU 102 and/or UPF 184 may determine a suitable repartition of PDUs in the PDU set among the available accesses, such as based on a (e.g., current) PLR measurement on each access, a PDU set size (e.g., which may be used to estimate the number of PDUs in the PDU set), and/or a (e.g., target) PSER configured for any of the service flow, QoS flow, and/or PDU set. For example, the repartitioning of PDUs may be determined by the WTRU 102 and/or UPF 184 to ensure that an effective loss rate for the PDU set, obtained by sending the PDUs of the set over a combination of accesses, is lower than a (e.g., configured) PSER. For example, where a target PSER can only be satisfied by a first access because the corresponding PLR is below a threshold while a second access has a larger PLR, then the WTRU 102 and/or UPF 184 may steer PDUs on the first access.

For example, PSER estimation-based access selection may be useful to optimize the usage of the accesses, such as to meet a configured PSER without committing to more network resources than necessary.

For example, the configuration information that may be used to execute the PSER estimation-based access selection algorithm may include a target PSER for any PDU sets.

In certain representative embodiments, a PSDB estimation-based access selection algorithm may be executed by a WTRU 102 and/or UPF 184. When a PSDB estimation-based access selection algorithm is selected, when a PDU of a PDU set is available for steering, the WTRU 102 and/or UPF 184 may determine an access to use for transmission, such as based on a current RTT measurement on each access, current congestion information, transmission queue occupation measurements, PDU set size (e.g., which can be used to estimate the number of remaining PDUs in the PDU set), and/or the PSDB configured for the service flow, QoS flow, and/or PDU set. For example, the WTRU 102 and/or UPF 184 determination aims to keep the effective transmission delay for the PDU set lower than the configured PSDB.

For example, PSDB estimation-based access selection may be useful to optimize the usage of the accesses and/or to meet the configured PSDB without committing to more network resources than necessary. For example, in a case where there is enough margin to meet the target PSDB, a (e.g., slightly) slower access may be used for any (e.g., all or most) PDUs in a PDU set.

For example, PSDB estimation-based access selection may (e.g., also) be useful to correct, when possible, situations where a PDU set is late. For example, in cases where the WTRU 102 and/or UPF 184 receives (e.g., latest one or more) PDUs of a PDU set with little time left to meet the PSDB, the WTRU 102 and/or UPF 184 may determine to transmit these (e.g., last few) PDUs through different available accesses, especially accesses with a low RTT.

For example, the configuration information that may be used to execute the PSDB estimation-based access selection algorithm may include a target PSDB for any PDU sets.

In certain representative embodiments, a Burst-aware access selection algorithm may be executed by a WTRU 102 and/or a UPF 184. When a Burst-aware access selection algorithm is selected, the WTRU 102 and/or UPF 184 may ensure that burst access(es) (e.g., an access selected for transmitting the initial PDUs of a burst, such as initial PDUs carrying base layer or independent frame information) will be readily available when the burst starts. After receiving the first PDU of a burst, the WTRU 102 and/or UPF 184 may start a timer configured with a burst periodicity, and stop transmitting PDUs (e.g., PDUs from other SDFs) on the burst access(es) based on determining that the PDUs (e.g., of the burst) are still queued for transmission when the timer sets off (e.g., after a configured time interval).

For example, burst-aware access selection may be useful to reduce jitter associated with XR traffic bursts.

For example, the configuration information that may be used to execute a Burst-aware access selection algorithm may include a list of accesses to use for sending initial PDUs of bursts.

In certain representative embodiments, a PDU set dependence-based access selection algorithm may be executed by a WTRU 102 and/or a UPF 184. When a PDU set dependence-based access selection algorithm is selected, the WTRU 102 and/or UPF 184 may use the PDU set dependence IEs associated with a PDU to determine the access to transmit the PDU on. For example, the WTRU 102 and/or UPF 184 may send any (e.g., all) dependent PDU sets (e.g., PDU sets which are dependent on one another) on one access, and/or may send any (e.g., all) independent PDU sets (e.g., PDU sets which are not dependent on one another) on another access. In another example, the WTRU 102 and/or UPF 184 may send an independent PDU set and any (e.g., all) PDU sets that depend on the independent PDU set over a same access. In another example, the WTRU 102 and/or UPF 184 may load-balance any independent PDU sets between available accesses.

For example, PDU set dependence-based access selection may be useful to provide a different level of service to independent versus dependent PDU sets (e.g., frames or layers). Load-balancing independent PDU sets may limit the impact of a late independent PDU set on other PDU sets and/or QoE.

For example, the configuration information that may be used to execute a PDU set dependence-based access selection algorithm may include a set of tuples (e.g., dependency, access and/or steering algorithm) which associate an access or steering algorithm with a “dependency” IE. For example, a dependency IE which may indicate “independent” (e.g., to match all independent PDU sets), “dependent” (e.g., to match all dependent PDU sets), or “dependent-group” (e.g., to match an independent PDU set and all its dependent PDU sets in one group). For example, “dependent-group” and “load balancing algorithm” may cause load balancing for groups of inter-dependent PDU sets between accesses, such as with each group (e.g., of dependent PDU sets) being entirely transmitted over one access.

In certain representative embodiments, a PDU set layer-based access selection algorithm may be executed by a WTRU 102 and/or a UPF 184. When a PDU set layer-based access selection algorithm is selected, the WTRU 102 and/or UPF 184 may use the PDU set layer IE associated with a PDU to determine the access to transmit the PDU on. For example, the WTRU 102 and/or UPF 184 may send all layer-0 (e.g., base layer) PDU sets on one access, and PDU sets associated with any other (e.g., all non-base) layers on another access. In another example, the WTRU 102 and/or UPF 184 may load-balance PDU sets of a (e.g., base) layer between available accesses.

In another example, different steering algorithms may be associated with each layer of a media flow. For example, PDUs carrying a first (e.g., base) layer may have a redundant steering algorithm (e.g., sent over both/all accesses) applied, PDUs carrying a second (e.g., non-base) layer may have a lowest delay steering algorithm applied, and/or PDUs carrying a third layer may have another steering algorithm applied, such as being sent over Wi-Fi access.

For example, PDU set layer-based access selection may be useful to provide a different level of service to a first layer (e.g., base layer) versus PDU sets carrying other (e.g., non-base) layers. Load-balancing of the first layer (e.g., layer-0) PDU sets may limit the impact of any late first layer PDU set on the next.

For example, the configuration information that may be used to execute a PDU set layer-based access selection algorithm may include a set of tuples (e.g., layer ID, access or steering algorithm) which associate an access or steering algorithm with a layer ID.

In certain representative embodiments, a Measurement-based selection algorithm may be executed by a WTRU 102 and/or a UPF 184. When a Measurement-based selection algorithm is selected, multiple sets of access selection algorithms may each be associated with different measurement thresholds and/or ranges. Measurement thresholds and/or ranges may be in term of any of burst jitter, minimum PDU set loss rate, minimum effective PDU Set delay, and/or other types of measurements, such as RTT, packet loss rate. Based on the value of obtained measurements, such as measurements described herein, the WTRU 102 and/or UPF 184 may select the appropriate set of selection algorithms (e.g., legacy algorithms and/or algorithms described herein). For example, when the link conditions are bad (e.g., one or more measurements above one or more thresholds), the WTRU 102 and/or UPF 184 may apply a combination of several steering algorithms, such as burst-aware access selection, PSER and/or PSDB estimation-based access selection. When link conditions improve (e.g., one or more measurements below one or more thresholds), the WTRU 102 and/or UPF 184 may change the applied steering algorithms (e.g., revert back to a simpler set of steering algorithms).

In another example, different steering algorithms may be associated with different link quality estimations from an AI/ML algorithm. The AI/ML algorithm, running on the WTRU 102 or on a network node, may use measurements, such as packet loss, PDU set loss, packet delay, and/or PDU set delay, and output a quality estimation (e.g., global or per-link). Based on configuration information associating the quality estimations with steering modes, the WTRU 102 and/or UPF 184 may determine which steering mode to apply. For example, high quality (e.g., above a first threshold) Wi-Fi may correspond to use of a first steering mode, such as using Wi-Fi access as a primary link. For example, average quality (e.g., between the first threshold and a second threshold) Wi-Fi may correspond to a second steering mode, such as a lowest-RTT steering mode. For example, low-quality (e.g., below the second threshold) Wi-Fi may lead to using a third steering mode, such as cellular access as the primary link.

In another example, the AI/ML algorithm may obtain QoE measurements (e.g., display buffer size, video freeze time, etc.) from the WTRU 102 application as input. The output of the AI/ML may be a QoE rating that is used as input by the WTRU 102 to select a steering mode. For example, the WTRU 102 may make this selection based on configuration information associating rating ranges with a steering algorithm.

For example, a measurement-based algorithm selection may be useful to dynamically adapt to varying link conditions, and/or apply different tradeoffs between QoE and processing in the WTRU 102 and/or UPF 184, such as depending on the link conditions.

For example, the configuration information that may be used to execute a Measurement-based selection algorithm may include a set of tuples (e.g., measurements thresholds, set of applicable steering algorithms or modes) where measurement thresholds identify the type of measurement (e.g., including measurement provided by other functions such as an AI/ML function) and a threshold value.

### PDU Set-Aware Steering Mode Configuration

In certain representative embodiments, selection of a steering algorithm (or set of steering algorithms) to use may be predetermined and/or set during establishment and/or updating of a MA-PDU session to carry a service flow.

In certain representative embodiments, a mobile system may define multiple PDU set-aware steering modes, each mode comprising one or more of the algorithms described herein. For example, an AF (e.g., through an NEF and/or PCF APIs) and/or operator may configure PCC rules in an SMF 183 associating a PDU set-aware steering mode with an SDF. The SMF 183, based on the PCC rule, may configure a UPF 184 and/or a WTRU 102 to use one or more of the PDU set-Aware steering modes. For example, the SMF 183 may use an N4 message to send the configuration information to a UPF 184. For example, the SMF 183 may use a NAS-SM message to send the configuration information to a WTRU 102.

For example, a PDU set-Aware steering mode may use duplication for high importance traffic, use split PDU set access selection for other PDU sets that are using FEC, and/or use complete PDU set access selection (e.g., for load balancing between PDU sets) for other PDU sets not using FEC.

In certain representative embodiments, the configuration of a PDU set-Aware steering mode (e.g., in NEF API, PCC rule, SMF 183, WTRU 102, UPF 184, N4 message, and/or ATSSS rule) may include a PDU set-aware steering mode ID and associated parameters (e.g., to identify one or more steering algorithms to use with the identified steering mode). For example, a PDU set-Aware steering mode ID may refer to or otherwise identify the definition of a steering mode including one or more steering algorithms described herein. For example, the definition may be standardized and/or otherwise defined by a network operator. For example, the parameters may describe (e.g., configure) individual steering algorithms and/or may configure combinations of PDU set-aware steering algorithms and/or legacy steering algorithms.

For example, the configuration information may provide a WTRU 102 and/or UPF 184 with a list of steering modes. In addition to configuring the steering modes per SDF and/or per application, any PDU set-Aware Steering Modes may be configured per PDU set and/or per PDU set type. For example, a steering mode may apply to any (e.g., all) PDUs that are in a PDU set, to any (e.g., all) PDUs that are in a PDU set of a specific type, or to any (e.g., all) PDUs that are in a PDU set with specific PDU set information of a specific type. A WTRU 102 and/or UPF 184 may determine to use a PDU set-Aware steering mode based on matching traffic descriptor information (e.g., application descriptor and/or IP descriptor) associated with the steering mode, by matching PDU set information associated with the steering mode, and/or by matching a combination of traffic descriptor information and PDU set information.

In certain representative embodiments, traffic descriptor information of an ATSSS rule (e.g., for a WTRU 102) or N4 rule (e.g., for a UPF 184), may include an application descriptor and/or an IP descriptor. For example, the ATSSS rule (e.g., the traffic descriptor information) may include (e.g., be enhanced to also include) a PDU set descriptor. For example, a PDU set descriptor may include one or more filters based on PDU set information. For example, a PDU set descriptor may include an importance filter (e.g., with values such as “importance lower than value X”, “any importance”, “importance equals to Y”, etc.), a PDU set size filter (e.g., with possible values such as “PDU set size less than X”, “any PDU set size”, “PDU set size equals to Y”, etc.), and/or other similar filters based on PDU Set IEs described herein. For example, WTRU 102 and/or UPF 184 may use an enhanced traffic descriptor to select a rule that should be applied to a given PDU, using the PDU set descriptor component of the traffic descriptor, if provided. The WTRU 102 and/or UPF 184 may apply a steering mode of the selected rule to a corresponding PDU.

### MA-PDU Session with PDU Set-Aware Steering Mode

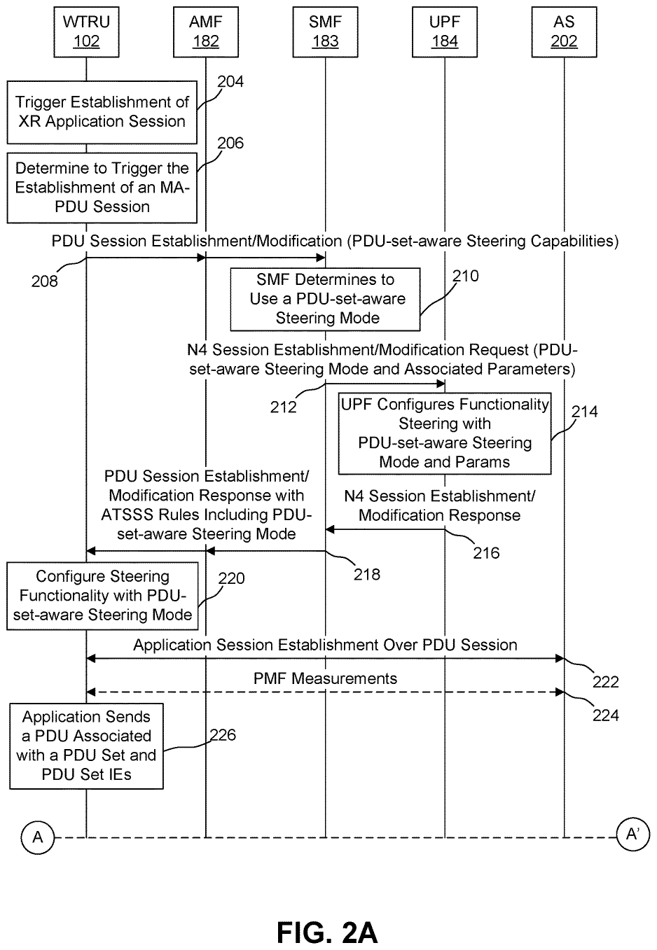

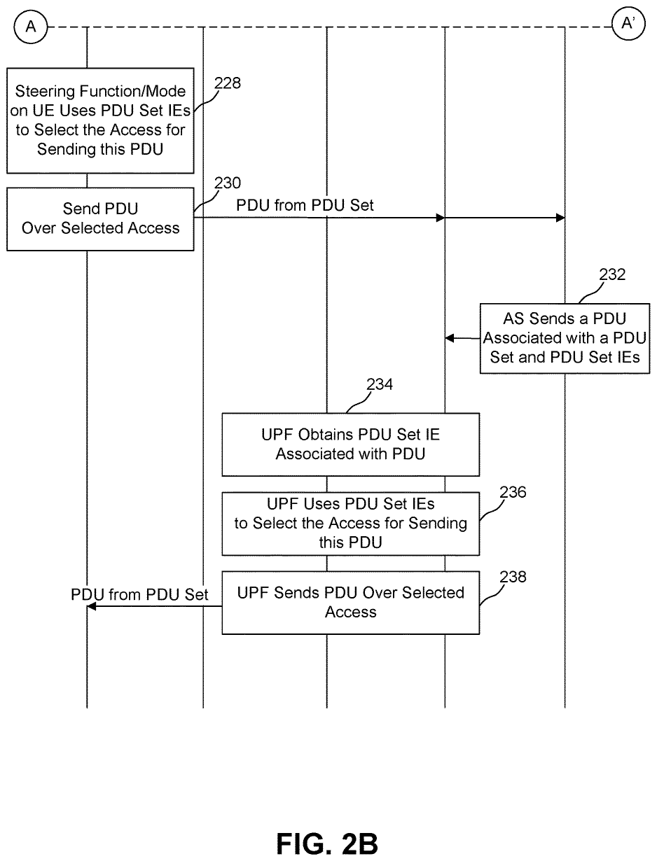

FIGS. 2A and 2B are a procedural diagram illustrating example communications for establishment and/or modification and operation of a MA-PDU session using a PDU set-aware steering mode.

In certain representative embodiments, a WTRU 102 may perform a procedure (e.g., communicate with an AMF 182, UPF 184, AS 202) to use PDU set-aware steering as shown in FIGS. 2A and 2B.

In certain representative embodiments, a UPF 184 may perform a procedure (e.g., communicate with an SMF 183, AS 202, WTRU 102) to use PDU set-aware steering as shown in FIG. 2.

In certain representative embodiments, it may be assumed that a WTRU 102 has registered with the network and received a registration response from the network. For example, the network (e.g., AMF 182) may send (e.g., in a registration response) information indicating “network support for PDU set-aware steering” to the WTRU 102 prior to 204 in FIG. 2. This may inform the WTRU 102 as to whether the network supports PDU set-aware steering (e.g., modes) and related mechanisms described herein, or if the network does not support the same. The WTRU 102 may use this information to determine if the WTRU 102 requests PDU set-aware steering modes. For example, the WTRU 102 may include PDU set-aware steering modes in the ATSSS capabilities of the WTRU 102 at 208, if the network has indicated “network support for PDU set-aware steering”, and the WTRU 102 may not include PDU set-aware steering modes in the ATSSS capabilities at 208, if the network did not indicate “network support for PDU set-aware steering”.

At 204 in FIG. 2, the WTRU 102 may trigger the establishment of an XR application session. For example, a WTRU 102 application may initiate a connection with an XR AS.

At 206, the WTRU 102 may determine to trigger the establishment of a MA-PDU session. For example, the WTRU 102 may select a URSP rule corresponding to the application session. The selected URSP rule may indicate that a MA-PDU session should be used. In some representative embodiments, the selected URSP rule may indicate that one or more PDU set-aware steering modes are suitable or available for this connection.

At 208, the WTRU 102 may send an PDU session establishment or modification request to the network indicating that a MA-PDU session is requested. This request message may be sent in a NAS-SM message. The message may be sent to the SMF 183 via the AMF 182. The WTRU 102 may indicate, as part of ATSSS capabilities of the WTRU 102 indicated in the request, support for any of the PDU set-aware steering modes described herein. The WTRU's ATSSS capabilities may indicate that the WTRU 102 does, or does not, support a respective PDU set-aware steering mode. The WTRU 102 may select a network slice, or network slice type, that is known to support PDU set-aware steering (e.g., the WTRU supported modes). For example, an existing or new Slice/Service type (SST) for carrying multimedia and/or XR traffic may include support for PDU set-aware steering modes. In this case, a WTRU 102 may select a NSSAI whose SST portion value is included in a set of SST values known to support PDU set-aware steering modes. In another example, a parameter (e.g., a fixed position bit) in the NSSAI may indicate support for PDU set-aware steering modes (e.g., possibly along with other PDU set related features).

At 210, upon receiving the PDU session establishment or update (e.g., modification) request, the SMF 183 may select a UPF 184. The SMF 183 may use the WTRU's ATSSS capabilities, the UPF's ATSSS capabilities, network configuration, user profile and/or policy rules to determine a steering functionality and/or a PDU set-aware steering mode (e.g., along with related parameters).

For example, the SMF 183 may receive ATSSS capabilities of the UPF 184 including “PDU set-awareness support” (e.g., a capability for the UPF 184 to support for one or more PDU set-aware steering modes as described herein) of the UPF 184 from a local SMF configuration, from network management messages, and/or from UPF capabilities advertisement messages from the UPF 184. The SMF 183 may select a UPF 184 based on the ATSSS capabilities of the UPF 184. If PDU set-aware steering is needed for downlink traffic, the SMF 183 may select a UPF 184 that supports PDU set-aware steering modes. If no such UPF 184 is available for selection, the SMF 183 may select a non-PDU set-aware UPF 184 and may then select a non-PDU set-aware steering mode for downlink traffic.

For example, the SMF 183 may receive ATSSS capabilities of the WTRU 102, including “PDU set-awareness support” (e.g., a capability for the WTRU 102 to support for one or more PDU set-aware steering modes as described herein) of the WTRU 102 in a NAS-SM message from the WTRU 102 (e.g., the PDU session establishment or modification at 208), or in a message from the AMF 182. The AMF 182 may obtain the “PDU set-awareness support” from the WTRU 102 in a NAS-MM message. When the SMF 183 determines the WTRU 102 does not have “PDU set-awareness support”, the SMF 183 may not select a PDU set-aware steering mode for uplink traffic. When the SMF 183 determines the WTRU 102 does have “PDU set-awareness support”, the SMF 183 may select a PDU set-aware steering mode for uplink traffic.

For example, the SMF 183 may determine that PDU set-awareness is desired or not in a network, for a DNN, for a network slice (e.g., S-NSSAI), for a network slice type, and/or for a user. For example, the SMF 183 may determine based on (e.g., network-wide, per-DNN and/or per-slice) configuration from the network operator that PDU set-aware steering modes are supported or not in this network (or for a given DNN or network slice or network slice type) corresponding to the MA-PDU session establishment/modification parameters provided at 208. For example, the SMF 183 may use an IE of the user profile (e.g., “PDU set-awareness support”) that indicates that (e.g., all, or specific) PDU set-aware steering modes are available or preferred, or not available nor preferred, for this user.

For this MA-PDU session, the SMF 183 may obtain a requested steering mode and related parameters from policy information. For example, the SMF 183 may obtain PCC rules from the PCF that are associated with the requested connection and/or flows and/or that include (e.g., in MA PDU session control information) a steering mode to use. A PCC rule may include (e.g., in MA PDU session control information) an indication that a PDU set-aware steering mode is allowed, suitable, or requested. A PCC rule may request or specify a PDU set-aware steering mode. A PCC rule may include associated PDU set-aware steering mode parameters. A PCC rule may associate a PDU set-aware steering mode with downlink traffic, uplink traffic, or both (e.g., using a downlink, uplink, or “uplink and downlink” indication in the rule).

For example, based on the “PDU set-awareness” capabilities in the WTRU 102 and UPF 184, based on “PDU set-awareness” support by the network, DNN, slice and/or user, and based on a requested steering mode for uplink and/or downlink, the SMF determine the steering mode to use for this MA-PDU session (e.g., a PDU set-aware steering mode for uplink and/or downlink). The SMF 183 may prepare the associated N4 rules for the UPF 184 and/or ATSSS rules for the WTRU 102.

At 212, the SMF 183 may send a N4 session establishment or modification request to the UPF 184. For example, the SMF 183 may include IEs that identify a steering functionality, a PDU set-aware steering mode and associated parameters. In another example, where a PDU set-aware steering mode is used for uplink only, the N4 rules may not identify a PDU set-aware steering mode (in FIG. 2 it is considered that the N4 rules identify a PDU set-aware steering mode). The UPF 184 may require configuration information to execute the steering algorithms described herein and may require configuration information to know which algorithms to execute. Examples of the configuration information are described herein. The SMF 183 may deliver the configuration information to the UPF 184 (e.g., in an N4 message) at 212.

At 214, the UPF 184 may configure steering functionality to use the PDU set-aware steering mode provided by the SMF 183, such as using the provided parameters if any.

At 216, the UPF 184 may send a N4 session establishment or modification response to the SMF 183.

At 218, SMF 183 may send a PDU Session establishment or modification response to the WTRU 102. The response may include information indicating ATSSS rules that identify a PDU set-aware steering mode. The response may include associated parameters for the PDU set-aware steering mode. For example, the response may include multiple ATSSS rules, each rule associating traffic flows, steering functions and/or steering modes. This may result in some traffic flows being associated with a PDU set-aware steering mode, some traffic flows being associated with non-PDU set-aware steering modes, and/or some traffic flows not being associated with a steering mode. In another example, where a PDU set-aware steering mode is used for downlink only, the ATSSS rules may not identify a PDU set-aware steering mode. In FIG. 2, the case is considered where the ATSSS rules identify a PDU set-aware steering mode. The WTRU 102 may require configuration information to execute the steering algorithms described herein and may require configuration information to know which algorithms to execute. Examples of the configuration information are described herein. The SMF 183 may deliver the configuration information to the WTRU 102 in at 218 (e.g., in a NAS message).

At 220, the WTRU 102 may configure the steering functionality to use the PDU set-aware steering mode provided by the SMF 183, such as by using the provided parameters if any.

At 222, the PDU session is set up (e.g., over 2 or more accesses) and the application session can be established between the WTRU 102 and the AS 202 over this PDU session (e.g., the MA-PDU session triggered at 206). In some embodiments, where PMF is used, PMF measurements may be exchanged between the WTRU 102 and the UPF 184 at 224, including PDU set-related measurements as described herein.

At 226 to 232, the operation of a PDU set-aware steering mode is shown for uplink PDUs. For example, during the application session, the WTRU 102 may send media over the PDU session.

At 226, the WTRU 102 application may send a PDU associated with a PDU set and PDU set IEs. For example, the WTRU 102 may send a RTP packet over UDP, or a PDU as part of a MOQ stream. The PDU is associated with a PDU set (e.g., as a set of PDUs transporting a frame, a layer, or other ADU), and with PDU set IEs. The WTRU 102 may obtain the PDU set IEs as described herein.

At 228, the steering function of the WTRU 102, through its operation in the PDU set-aware steering mode, uses the PDU set IEs to select the access(es) for sending the PDU. The selection of the access(es) may be based on any of the access network selection algorithms that may be executed by the WTRU 102 as described herein.

At 230, the WTRU 102 forwards (e.g., sends) the PDU over the selected access, towards the AS 202. The data may be sent via the selected access and via the UPF 184.

At 234 to 238, the operation of a PDU set-aware steering mode is shown for downlink PDUs. For example, during the application session, the AS 202 may send media over the PDU session.

At 232, the AS 202 may send a PDU associated with a PDU set and PDU set IEs to the UPF 184. For example, the AS 202 may send an RTP packet over UDP, or a PDU as part of a MOQ stream. The PDU is associated with a PDU set (e.g., set of PDUs transporting a frame, a layer, or another ADU) and with PDU set IEs.

At 234, the UPF 184 may obtain the PDU set IEs as described herein.

At 236, the steering function of the UPF 184, through its operation in the PDU set-aware steering mode, uses the PDU set IEs to select the access for sending the PDU. The selection of the access may be based on any of access network selection algorithms that may be executed by the UPF 184 as described herein.

At 238, the UPF 184 forwards the PDU to the selected access, towards the WTRU 102.

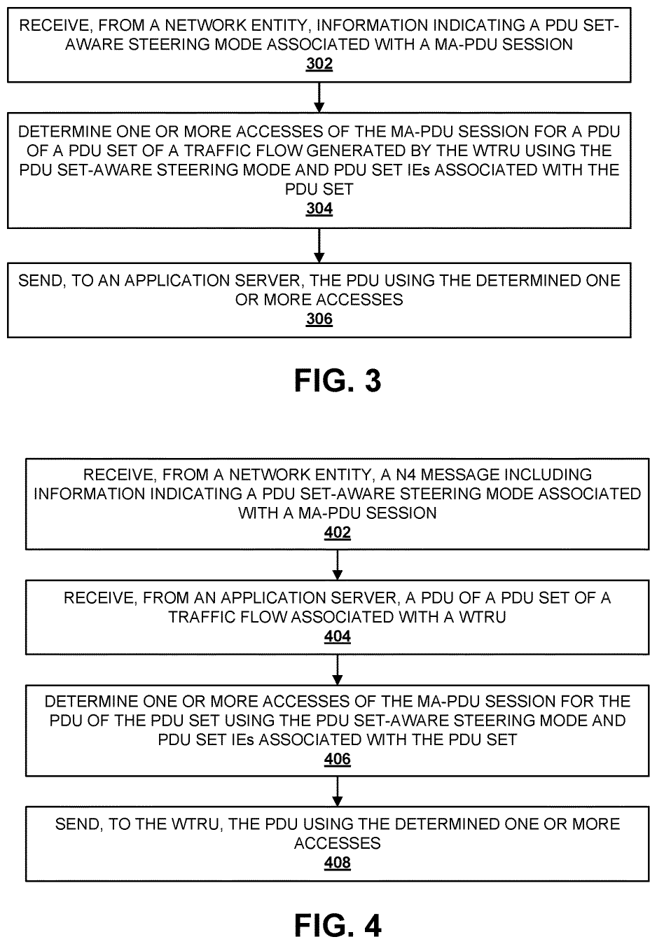

FIG. 3 is a procedural diagram illustrating an example procedure for PDU set-aware steering for uplink traffic. As shown in FIG. 3, a WTRU 102, may receive, from a network entity (e.g., SMF 183), information indicating a PDU set-aware steering mode associated with a MA-PDU session at 302. For example, the PDU set-aware steering mode may indicate to the WTRU 102 a steering algorithm (or combination thereof) as described herein to be applied to (e.g., steer) UL traffic to be sent over the MA-PDU session. At 304, the WTRU 102 may determine one or more accesses of the MA-PDU session for a PDU of a PDU set of a traffic flow generated by the WTRU 102. For example, the WTRU 102 may use the PDU set-aware steering mode and PDU set IEs associated with the PDU set. At 306, the WTRU 102 may send, to an AS 202, the PDU using the determined one or more accesses.

In certain representative embodiments, the MA-PDU session may include at least two of a 3GPP access, a non-3GPP access, a relay WTRU-based access, a PDU-set-aware access, and a non-PDU-set-aware access.

In certain representative embodiments, the traffic flow may be generated by an (e.g., XR) application executed by the WTRU 102.

In certain representative embodiments, the WTRU 102 may receive information indicating network support for PDU set-aware steering.

In certain representative embodiments, the WTRU 102 may send, to the network entity (e.g., SMF 183), a PDU session establishment or modification request which includes information indicating one or more requested PDU set-aware steering modes.

In certain representative embodiments, the WTRU 102 may send, to the network entity (e.g., SMF), a PDU session establishment or modification request which includes information indicating one or more PDU-set-aware steering capabilities supported by the WTRU.

In certain representative embodiments, the information indicating the PDU set-aware steering mode may be received in a PDU session establishment or modification response message, from the network entity (e.g., SMF 183), associated with the PDU session. For example, after receiving the PDU session establishment or modification response message, the WTRU 102 may establish an application session over the PDU session.

In certain representative embodiments, the information indicating the PDU set-aware steering mode may be included in one or more access traffic steering, switching and splitting (ATSSS) rules.

In certain representative embodiments, the PDU set IEs associated with the PDU set may include information indicating any of an identifier of the PDU set, a start indication of the PDU set, an end indication of the PDU set, a sequence number of the PDU, a size of the PDU set, an importance of the PDU set, an error rate of the PDU set, a delay budget of the PDU set, an integration indication for the PDU set, a burst and/or periodicity for the PDU set, a dependence of the PDU set, a payload modality of the PDU set, a forward error correction (FEC) indication for the PDU set, a FEC symbol type of the PDU, and/or a FEC algorithm for of the PDU set. For example, the WTRU 102 may use one or more of the PDU set IEs per the PDU set-aware steering mode (e.g., indicating a combination of steering algorithms) to determine which accesses to transmit the PDU over.

FIG. 4 is a procedural diagram illustrating an example procedure for PDU set-aware steering for downlink traffic. In FIG. 4, a first network entity may provide (e.g., execute) a UPF 184). As shown in FIG. 4, the first network entity may receive, from a second network entity (e.g., SMF 183), a N4 message including information indicating a PDU set-aware steering mode associated with a MA-PDU session at 402. For example, the PDU set-aware steering mode may indicate to the first network entity (e.g., UPF 184) a steering algorithm (or combination thereof) as described herein to be applied to (e.g., steer) DL traffic to be sent over the MA-PDU session. At 404, the first network entity may receive, from an AS 202, a PDU of a PDU set of a traffic flow associated with a WTRU 102. At 406, the first network entity may determine one or more accesses of the MA-PDU session for the PDU of the PDU set. For example, the first network entity may use the PDU set-aware steering mode and PDU set information elements IEs associated with the PDU set to determine the one or more accesses. At 408, the first network entity may send, to the WTRU 102, the PDU using the determined one or more accesses.

In certain representative embodiments, the second network entity may provide (e.g., execute) a SMF 183.

In certain representative embodiments, the MA-PDU session may include at least two of a 3GPP access, a non-3GPP access, a relay WTRU-based access, a PDU-set-aware access, and a non-PDU-set-aware access.

In certain representative embodiments, the traffic flow may be associated with an application executed by the WTRU 102.

In certain representative embodiments, the N4 message is a PDU session establishment or modification request.

In certain representative embodiments, the UPF 184 may send, to the second network entity (e.g., SMF 183), a N4 PDU session establishment or modification response.

In certain representative embodiments, the PDU set IEs associated with the PDU set may include information indicating any of an identifier of the PDU set, a start indication of the PDU set, an end indication of the PDU set, a sequence number of the PDU, a size of the PDU set, an importance of the PDU set, an error rate of the PDU set, a delay budget of the PDU set, an integration indication for the PDU set, a burst and/or periodicity for the PDU set, a dependence of the PDU set, a payload modality of the PDU set, a forward error correction (FEC) indication for the PDU set, a FEC symbol type of the PDU, and/or a FEC algorithm for of the PDU set. For example, the UPF 184 may use one or more of the PDU set IEs per the PDU set-aware steering mode (e.g., indicating a combination of steering algorithms) to determine which accesses to transmit the PDU over.

While the mechanisms described herein were described for use with multi-access PDU sessions, they can more generally be applied to the distribution of traffic across other sessions and/or accesses. For example, the mechanisms described herein may be applied to the distribution of traffic across multiple (non-multi-access) PDU sessions.

In certain representative embodiments, a WTRU 102 may receive, from a network entity, information indicating a PDU set-aware steering mode associated with a PDU session. The WTRU 102 may determine one or more steering algorithms associated with the PDU set-aware steering mode. The WTRU 102 may determine one or more accesses associated with the PDU session for a PDU of a PDU set associated with a traffic flow generated by the WTRU using the one or more steering algorithms and PDU set information elements associated with the PDU set. The WTRU may send, to an application server, the PDU using the determined one or more accesses.

For example, the information indicating the PDU set-aware steering mode is received in an establishment or modification response message from the network entity and is associated with the PDU session. For example, the PDU session may be a MA-PDU session.

For example, the traffic flow is generated by an application executed by the WTRU 102.

For example, the PDU set IEs may include information indicating any of an identifier, a start indication, an end indication, a sequence number, a size, an importance, an error rate, a delay budget, an integration indication, a burst and/or periodicity, a dependence, a payload modality, and/or a forward error correction indication of the PDU set.

For example, the WTRU 102 may, before receiving the information indicating the PDU set-aware steering mode, receive information indicating network support for PDU set-aware steering.

For example, the WTRU 102 may send, to the network entity, a PDU establishment or modification request which includes information indicating one or more requested PDU set-aware steering modes. As an example, the information indicating the PDU set-aware steering mode (e.g., from the network entity) may indicate any (e.g., one) of the one or more requested PDU set-aware steering modes.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), the method comprising:
receiving, from a network entity, information indicating a protocol data unit (PDU) set-aware steering mode associated with a multi-access PDU (MA-PDU) session;
determining one or more accesses of the MA-PDU session for a PDU of a PDU set of a traffic flow generated by the WTRU using the PDU set-aware steering mode and PDU set information elements (IEs) associated with the PDU set; and
sending, to an application server via the MA-PDU session, the PDU using the determined one or more accesses.

2. The method of claim 1, wherein the MA-PDU session uses at least two of a third generation partnership project (3GPP) access, a non-3GPP access, a relay WTRU-based access, a PDU-set-aware access, and a non-PDU-set-aware access.

3. The method of claim 1, wherein the traffic flow is generated by an application executed by the WTRU.

4. The method of claim 1, further comprising:
receiving information indicating network support for PDU set-aware steering.

5. The method of claim 1, further comprising:
sending, to the network entity, a PDU session establishment or modification request which includes information indicating one or more requested PDU set-aware steering modes.

6. The method of claim 1, further comprising:
sending, to the network entity, a PDU session establishment or modification request which includes information indicating one or more PDU-set-aware steering capabilities supported by the WTRU.

7. The method of claim 1, wherein the information indicating the PDU set-aware steering mode is received in a PDU session establishment or update response message from the network entity and is associated with the MA-PDU session.

8. The method of claim 7, further comprising:
after receiving the PDU session establishment or update response message, establishing an application session, with an application server, over the PDU session.

9. The method of claim 1, wherein the information indicating the PDU set-aware steering mode is included in one or more access traffic steering, switching and splitting (ATSSS) rules.

10. The method of claim 1, wherein the PDU set IEs associated with the PDU set include information indicating any of an identifier of the PDU set, a start indication of the PDU set, an end indication of the PDU set, a sequence number of the PDU, a size of the PDU set, an importance of the PDU set, an error rate of the PDU set, a delay budget of the PDU set, an integration indication for the PDU set, a burst and/or periodicity for the PDU set, a dependence of the PDU set, a payload modality of the PDU set, a forward error correction (FEC) indication for the PDU set, a FEC symbol type of the PDU, and/or a FEC algorithm for of the PDU set.

11. A wireless transmit/receive unit (WTRU) comprising:
a processor, memory, and a transceiver which are configured to:
receive, from a network entity, information indicating a protocol data unit (PDU) set-aware steering mode associated with a multi-access PDU (MA-PDU) session,
determine one or more accesses of the MA-PDU session for a PDU of a PDU set of a traffic flow generated by the WTRU using the PDU set-aware steering mode and PDU set information elements (IEs) associated with the PDU set, and
send, to an application server via the MA-PDU session, the PDU using the determined one or more accesses.

12. The WTRU of claim 11, wherein the MA-PDU session uses at least two of a third generation partnership project (3GPP) access, a non-3GPP access, a relay WTRU-based access, a PDU-set-aware access, and a non-PDU-set-aware access.

13. The WTRU of claim 11, wherein the traffic flow is generated by an application executed by the WTRU.

14. The WTRU of claim 11, wherein the processor, memory, and the transceiver are configured to:
receive information indicating network support for PDU set-aware steering.

15. The WTRU of claim 11, wherein the processor, memory, and the transceiver are configured to:
sending, to the network entity, a PDU session establishment or modification request which includes information indicating one or more requested PDU set-aware steering modes-to a

16. The WTRU of claim 11, wherein the processor, memory, and the transceiver are configured to:
send, to the network entity, a PDU session establishment or modification request which includes information indicating one or more PDU-set-aware steering capabilities supported by the WTRU.

17. The WTRU of claim 11, wherein the information indicating the PDU set-aware steering mode is received in a PDU session establishment or update response message from the network entity and is associated with the MA-PDU session.

18. The WTRU of claim 17, wherein the processor, memory, and the transceiver are configured to:
after receiving the PDU session establishment or update response message, establishing an application session, with an application server, over the PDU session.

19. The WTRU of claim 11, wherein the information indicating the PDU set-aware steering mode is included in one or more access traffic steering, switching and splitting (ATSSS) rules.

20. The WTRU of claim 11, wherein the PDU set IEs associated with the PDU set include information indicating any of an identifier of the PDU set, a start indication of the PDU set, an end indication of the PDU set, a sequence number of the PDU, a size of the PDU set, an importance of the PDU set, an error rate of the PDU set, a delay budget of the PDU set, an integration indication for the PDU set, a burst and/or periodicity for the PDU set, a dependence of the PDU set, a payload modality of the PDU set, a forward error correction (FEC) indication for the PDU set, a FEC symbol type of the PDU, and/or a FEC algorithm for of the PDU set.
